(19) United States
(12) Patent Application Publication
(10) Pub. No.: US 2004/0063060 A1
(43) Pub. Date: Apr. 1, 2004

(54) Intraoral illumination device

(76) Inventors: Douglas B. Meyers, Los Angeles, CA (US); Rob Burman, Tujunga, CA (US)

Correspondence Address: STEVENS, DAVIS, MILLER & MOSHER, LLP, Suite 850, 1615 L Street N.W., Washington, DC, 20036, US

(21) Appl. No.: 10/259,658

(22) Filed: Sep. 30, 2002

(51) Int. Cl. A61C 1/00

(52) U.S. Cl. 433/29

(57) ABSTRACT

The present invention is a novelty or dental device including a pair of light units secured to the inside of the mouth of a user. A flexible band is placed between the gums and lips of the user, such that the light units are placed over the molars in the back of the mouth.

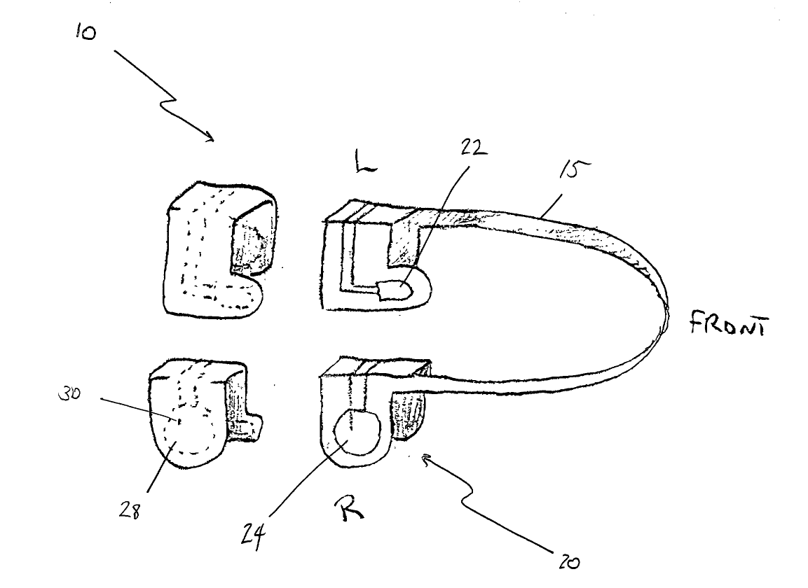

### BACKGROUND

1. Field of the Invention

The present invention relates the field of devices for illuminating the interior of the oral cavity of a user. Specifically, the invention includes a strip or other apparatus for securing the device inside the mouth and at least one light source, such as an LED.

2. Background of Related Art

Products which can be placed inside the mouth of a user are known. For example, U.S. Pat. No. 6,299,441, No. 5,989,023 and No. 5,152,686, each of which are herein incorporated by reference in their entireties, each teach a device for insertion into the oral cavity.

### SUMMARY OF THE INVENTION

The intraoral cavity illumination device of the invention is an adjustable and shapeable device that is placed into the mouth with a self-contained light source to illuminate the mouth. While the device may simply be used as a novelty item, the invention may also be used by a dentist to provide light inside the mouth of a user. Additionally, if the light source is an ultraviolet light, the device of the invention may also be used to cure dental adhesives or other intraoral materials.

Typically, the light source includes one or more LED's which go down and over the teeth and are bent into the open area into the mouth. Such light sources may be of a constant glow, may blink or transmit any pattern of light, in white, or any other color, including ultraviolet and “blacklight”.

Additionally, the strip may be replaced with a pressure mount. In such a configuration, the light sources are secured in the mouth of the user by applying pressure between the back molars, instead of using a strip around the teeth. Such a pressure mount may also include the use of an adhesive to temporarily affix the device to the roof of the mouth.

Finally, the device of the invention may also include an activation module. The activation module may be a simple switch, to be actuated when the device is installed in the mouth, or alternatively, may include a button or other actuator located on the device to be actuated by the tongue or lips of the user.

### BRIEF DESCRIPTION OF THE DRAWINGS

The FIGURE is an exploded view of the invention.

### DETAILED DESCRIPTION OF THE INVENTION

An intraoral illumination device 10 is shown in the FIGURE, as described in U.S. Provisional Application No. 60/290,780, filed May 15, 2001, and Patent Disclosure Document No. 480,319, filed Sep. 28, 2000, each of which is herein incorporated by reference in its entirety. Specifically, the device 10 includes a strip 15 separating a pair of self-contained light units 20, free from electrical or other connections out of the mouth of the user, each including a light emitter 22 and a battery 24. Preferably, a cover 28 is provided to protect the light units 20. Due to its construction, the device 10 can be worn over the upper teeth or the lower teeth.

The cover 28 is preferably provided with a backing to direct the light generated by the device in the desired direction. Typically, when the device 10 is used as a novelty device, the user wishes to transmit the light forward, i.e., out of the mouth, in which case, the cover 28 includes an opaque backing to direct the light forward. When the device is used by a dentist to illuminate the lower teeth, the cover 28 can be provided with an appropriate opaque backing.

During use, a user places both light units 20 at the rear of the mouth with the strip 15 around the front of the teeth. Preferably, the strip 15 is placed between the gums and the lips, such that the strip 15 is not ordinarily visible. Although depicted as a relatively thin structure that extends only over a portion of the gums, strip 15 may be replaced by a traditional mouth guard, covering the entire teeth.

In another embodiment, strip 15 may be replaced with a means for securing the light units 20 without a strip around the front teeth. For example, light units 20 may be suspended from a device, such as a traditional biteplate or holding wires designed to stabilize the device by inserting into the spaces between teeth, or may be secured by applying pressure to the back molars or other teeth of the user, or with traditional orthodontia, such as bands about the molars or brackets affixed to the surfaces of the teeth. Finally, the light units 20 can be anchored to the roof of the mouth or teeth with a, preferably, removable adhesive.

In one embodiment, the light units 20 each include a single light emitter 22 and battery 24 as power source. In such an embodiment light emitter 22 can be any light generating apparatus requiring an external power source, such as an incandescent light bulb, light emitting diode, collimated light bulb, laser device, or polarized light generator. However, because “light” as used throughout this description and the claimed appended hereto, is used to mean any wavelength of light (i.e., visible or not visible), light emitter 22 may also be used to produce infrared, ultraviolet or any wavelength of electromagnetic energy, ranging, for example from microwaves to radio frequencies and gamma rays.

Battery 24 is preferably replaceable, to permit multiple uses of the device 10, by simply removing cover 28 and installing a new battery. It is also considered within the scope of the invention to seal cover 28 in place to prohibit the removal of battery 24. In such an embodiment, battery 24 can be an electric power source which, when exhausted, requires disposal of the entire device 10.

Due to the wide range of possibilities for the light emitters 22, the invention has a wide range of uses. For example, when the light emitters are used to generate traditional white light, a dentist can put the device 10 inside the mouth of a user simply to enhance the visible field. However, when the light is in the ultraviolet spectrum, the device 10 may be used to cure dental materials.

Moreover, light emitters 22 and batteries 24 may be replaced to eliminate the need for separate pieces. For example, a chemiluminescent apparatus may be used, including an oxalate carrier and a fluorescent dye to emit chemiluminescent light when mixed with an activator. Such a chemiluminescent device may include a frangible barrier forming a separate compartment containing the oxalate solution and the activator solution, to be ruptured upon physical deformation of the barrier, as is understood in the art.

The device 10 of the invention may also be used to produce ultraviolet rays. In such an embodiment, light units 20 are replaced by ultraviolet generating devices, such that light units 20 can be placed at any desired location in the mouth to enable localized high-intensity curing of traditional dental adhesives.

Finally, the light unit 20 may be actuated in a number of different manners. In one embodiment, once the light unit 20 is removed from its packaging, light emitter 22 is actuated and simply runs until the power source is exhausted. Typically however, light unit 20 includes a button 30, preferably, positioned on the cover 28 to selectively actuate or energize light emitter 22. More preferably, the button 30 is positioned to be actuated by the tongue of the user, but is typically actuated before the device 10 is placed in the mouth.

Although the present invention has been described in terms of specific embodiments, it will be apparent to one skilled in the art that various modifications may be made according to those embodiments without departing from the scope of the applied claims and their equivalents. Accordingly, the present invention should not be construed to be limited to the specific embodiments disclosed herein.

I/we claim:

1. An intraoral illumination device for illuminating the oral cavity of a user, said device comprising:
at least one self-contained light unit;
optionally, at least one power source, connected to said at least one light unit;
means for securing said light unit inside the oral cavity of the user.

2. The intraoral illumination device of claim 1, wherein said securing means is selected from the group consisting of at least one bracket secured to at least one tooth, a flexible band and adhesives.

3. The intraoral illumination device of claim 2, wherein said band is curved as to be placed between the teeth and the lips of the user.

4. The intraoral illumination device of claim 3, comprising two light units, wherein said light sources are disposed at opposite ends of said band.

5. The intraoral illumination device of claim 4, wherein said light units comprise a cavity, designed to receive teeth of the user.

6. The intraoral illumination device of claim 5, wherein said power source is two batteries, each of said batteries independently connected one of said light units.

7. The intraoral illumination device of claim 6, wherein said batteries are each mounted to the respective light unit, such that said batteries are disposed on the outside of the cavity and the light units are disposed on the opposite side.

8. The intraoral illumination device of claim 1, wherein said power source comprises at least one battery.

9. The intraoral illumination device of claim 1, wherein said light unit comprises means for generating light.

10. The intraoral illumination means of claim 9, wherein said light generating means consists of at least an apparatus selected from the group consisting of incandescent light bulb, light-emitting diode and chemiluminescence device.
